(19) United States
(12) Patent Application Publication
(10) Pub. No.: US 2014/0366856 A1
(43) Pub. Date: Dec. 18, 2014

(54) CLOSED BREATHER SYSTEM

(71) Applicant: HINO MOTORS, LTD., Hino-shi Tokyo (JP)

(72) Inventor: Akio Kakinai, Tokyo (JP)

(73) Assignee: HINO MOTORS, LTD., Hino-shi Tokyo (JP)

(21) Appl. No.: 14/363,878

(22) PCT Filed: Jan. 17, 2013
(86) PCT No.: PCT/JP13/00193

§ 371 Date: Jun. 9, 2014

(30) Foreign Application Priority Data
Jan. 20, 2012 (JP) 2012-009858

(51) Int. Cl. F01M 13/00; F02M 25/08

(52) U.S. Cl. CPC F01M 13/0011; F02M 25/08
USPC 123/574

(57) ABSTRACT

In a closed breather system which returns blow-by gas 1 extracted, through a gas extraction tube 5, from an engine 3 to an intake tube 7 through a ventilator 2 for separation and recovery of oil mist, a three-way valve 13 is incorporated in the gas extraction tube 5 to temporarily switch a passage of the three-way valve 13 only while the engine 3 remains cold so as to release the blow-by gas 1 to the atmosphere.

### TECHNICAL FIELD

The present invention relates to a closed breather system.

### BACKGROUND ART

Blow-by gas leaking through a gap of a piston to a crank case during compression and expansion strokes of an engine, which may fill the crank case and a cylinder head cover in communication therewith, needs to be released outside. However, the crank case has therein a crankshaft, a connecting rod and the like which are in high-speed motion, and the cylinder head cover in communication with the crank case also has therein a rocker arm, a valve and the like which are in motion, so that the crank case and the cylinder head cover are full of oil mist.

Thus, release of the blow-by gas as it is to the atmosphere may cause any oil mist mixed in the blow-by gas to be also discharged outside, so that as shown in FIG. 1, provided is a ventilator 2 (Closed Crankcase Ventilator: CCV) having therein a filtering net or a labyrinth structure for separation and recovery of the oil mist in the blow-by gas 1. The blow-by gas 1 extracted from the cylinder head cover 4 of the engine 3 through a gas extraction tube 5 is passed to the ventilator 2 for separation and recovery of the oil mist and is returned through a gas return tube 6 to an intake tube 7 while oil 8 recovered in the ventilator 2 is returned through an oil recovery tube 9 to an oil pan 10 of the engine 3.

In a fire truck or other vehicle with a specific running mode having extremely short annual mileage and extremely short running time per running, at freezing cold start of an engine 3 having been out of operation for a long time, water vapor in the blow-by gas 1 may condense into dew condensation water 11 which is separated and accumulated together with the oil mist without evaporation in the ventilator 2 and is returned through the oil recovery tube 9 to the oil pan 10, resulting in troubles such as oil dilution.

Specifically, in a vehicle with an ordinary running mode, any dew condensation water 11 produced in the system at the cold start of the engine 3 is vapored again by full warm-up of the engine 3 and is discharged together with the blow-by gas 1 out of the system. However, in the use where the engine 3 is stopped before being fully warmed up, the dew condensation water 11 produced in the system remains accumulated without evaporation.

Thus, in such vehicle with the specific running mode, a catch tank 12 for separation and recovery of the dew condensation water 11 together with the oil 8 is incorporated in the oil recovery tube 9 so as to periodically extract the dew condensation water 11 and the oil 8 accumulated in the catch tank 12.

Further, non-return valves (not shown) are provided in the ventilator 2 adjacent to its outlet of the oil 8 and in the oil recovery tube 9 adjacent to its terminal so as to prevent backflow from the oil pan 10 to the ventilator 2.

Generally, the system with the closed circuit for dealing with the blow-by gas 1 as mentioned in the above is called a closed breather system. A prior art reference for this kind of closed breather system is, for example, Patent Literature 1 mentioned below.

### CITATION LIST

### Patent Literature

[Patent Literature 1] JP 2003-278523A

### SUMMARY OF INVENTION

### Technical Problems

However, when the dew condensation water 11 is produced and accumulated in such conventional closed breather system, mixing of the dew condensation water 11 with the oil 8 is facilitated by vibration to produce a highly viscous emulsion which may cause malfunction of the non-return valves and passage clogging in the ventilator 2 and in the oil recovery tube 9.

The invention was made in view of the above and has its object to provide a closed breather system which can prevent beforehand production and accumulation of dew condensation water in the system.

### Solution to Problems

The invention is directed to a closed breather system for returning blow-by gas extracted from an engine through a gas extraction tube to an intake tube, oil mist being separated and recovered from the blow-by gas through a ventilator, characterized in that a three-way valve is incorporated in said gas extraction tube such that a passage of the three-way valve is temporally switched only while the engine remains cold so as to release the blow-by gas to atmosphere.

In this manner, while the engine remains cold, the passage of the three-way valve is temporally switched to release the blow-by gas to the atmosphere, so that no dew condensation water is produced in the system. As a result, accumulation of dew condensation water in the system is prevented beforehand, so that mixing of dew condensation water with the oil into a highly viscous emulsion facilitated by vibration does not occur and there is no fear of malfunction of non-return valves and passage clogging in the ventilator and in the oil recovery tube due to this kind of emulsion.

When the engine is fully warmed up, the passage of the three-way valve is returned to its original position, so that the blow-by gas is not released to the atmosphere and is guided as it is to the ventilator for separation and recovery of the oil mist, and is returned to the intake tube. With the engine being fully warmed up, the water vapor in the blow-by gas does not condense, so that the water vapor is discharged out of the system together with the blow-by gas.

The release of the blow-by gas to the atmosphere is only for a short while during the engine remaining cold. In a normal use after the engine is fully warmed up, the blow-by gas is treated in the closed circuit so that environmental consequences by the release of the blow-by gas to the atmosphere are extremely petty.

Further, it is preferable that the invention is provided with cold-condition determining means for determining the engine to be in cold condition and a controller for switching the passage of the three-way valve on the basis of a detection signal from said cold-condition determining means to release the blow-by gas to the atmosphere. Further, it is preferable that the cold-condition determining means is a water temperature sensor for detecting a temperature of cooling water in the engine.

### Advantageous Effects of Invention

According to the closed breather system of the invention mentioned in the above, various excellent effects will be obtained as mentioned in the below.

(I) While the engine remains cold, the passage of the three-way valve is temporally switched to release the blow-by gas to the atmosphere, whereby dew condensation water is prevented beforehand from being produced and accumulated in the system while the engine remains cold; as a result, facilitated mixing of the dew condensation water with the oil due to vibration and thus production of the highly viscous emulsion can be also prevented. Thus, fear of malfunction of the non-return valve and passage clogging in the ventilator and in the oil recovery tube due to this kind of emulsion can be resolved.

(II) Production of the dew condensation water itself in the system while the engine remains cold can be prevented, which makes it unnecessary to incorporate a catch tank in the oil recovery tube so as to separate the dew condensation water. This can bring about substantial reduction in cost and can make it unnecessary to conduct troublesome and periodical removal of the dew condensation water and oil from the catch tank and cleaning of the interior of the tank.

### BRIEF DESCRIPTION OF DRAWINGS

FIG. 1 is an overall schematic view showing a conventional example; and

FIG. 2 is an overall schematic view showing an embodiment of the invention.

### DESCRIPTION OF EMBODIMENT

An embodiment of the invention will be described in conjunction with the drawings.

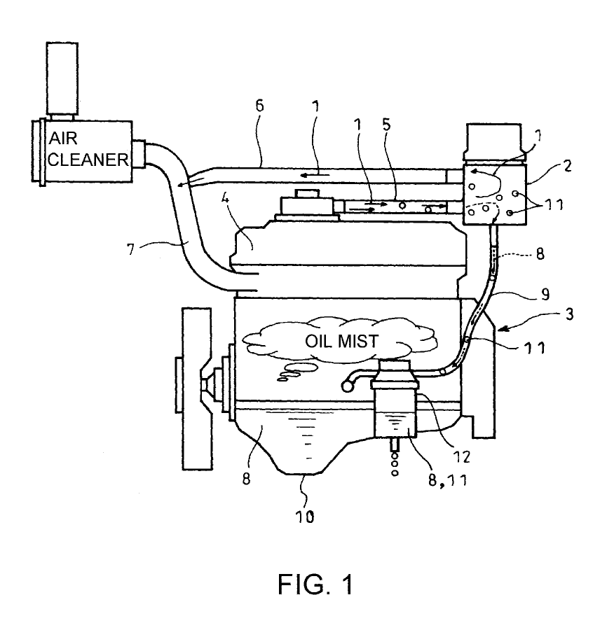

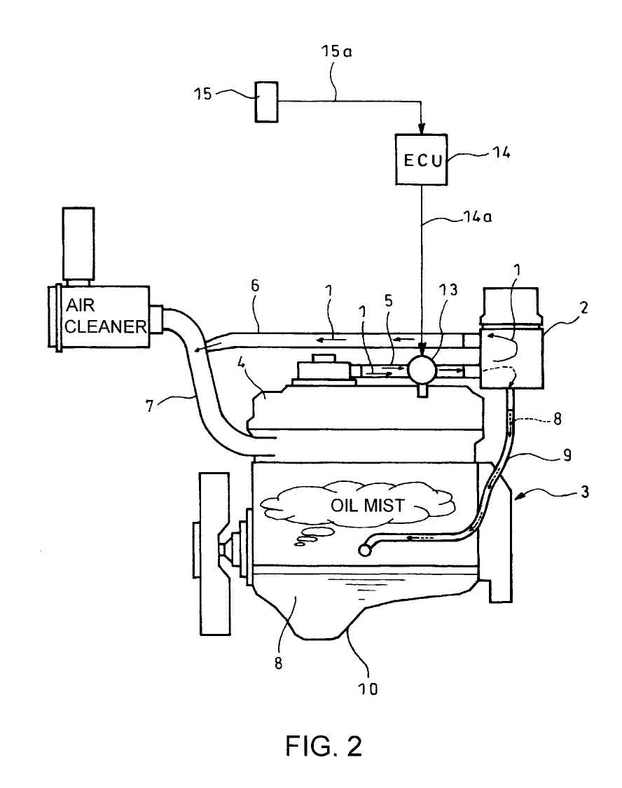

FIG. 2 shows the embodiment of the invention in which parts similar to those shown in FIG. 1 are represented by the same reference numerals.

As shown in FIG. 2, in the embodiment directed to a closed breather system constructed similarly to that shown in FIG. 1, incorporated in a gas extraction tube 5 for guiding blow-by gas 1 from an engine 3 to a ventilator 2 is a three-way valve 13 switchable into a first position where the blow-by gas 1 from the engine 3 is guided as it is to the ventilator 2 and into a second position where the blow-by gas 1 from the engine 3 is released to the atmosphere. On the basis of a control signal 14a from a controller 14 constituting an engine controlling computer (Electronic Control Unit: ECU), the three-way valve 13 is temporarily switched from the first position to the second position only while the engine 3 remains cold to thereby release the blow-by gas 1 to the atmosphere.

Inputted to the controller 14 is a detection signal 15a from a water temperature sensor 15 (cold-condition determining means) which detects a temperature of cooling water in the engine 3. When the temperature of the cooling water is, for example, about 70° C. or less, the controller determines the engine to be in cold condition where dew condensation water is dominantly produced, and outputs the control signal 14a to the three-way valve 13 for switching of the passage to the second position.

With the closed breather system thus constructed, for example, at cold start of the engine 3, the controller 14 determines, on the basis of the detection signal 15a from the water temperature sensor 15, the engine 3 to be in cold condition. Then, the control signal 14a from the controller 14 is outputted to the three-way valve 13 to thereby switch the passage of the three-way valve 13 from the first position to the second position where the blow-by gas 1 from the engine 3 is released to the atmosphere.

As a result, no dew condensation water is produced in the system at cold start of the engine 3, so that dew condensation water is prevented beforehand from being accumulated in the system, and facilitated mixing of dew condensation water with the oil 8 into a highly viscous emulsion due to vibration does not occur. There is no fear of the malfunction of the non-return valves and passage clogging in the ventilator 2 and in the oil recovery tube 9 due to this kind of emulsion.

When the engine 3 is fully warmed up, the passage of the three-way valve 13 is returned to the original first position and the blow-by gas 1 is, without release to the atmosphere, guided as it is to the ventilator 2 for separation and recovery of the oil mist and is returned to the intake tube 7. With the engine 3 fully warmed up, the water vapor in the blow-by gas 1 does not condense and thus is discharged together with the blow-by gas 1 out of the system.

The release of the blow-by gas 1 to the atmosphere is only for a short while during the engine 3 remaining cold. In the usual use after the engine 3 is fully warmed up, the blow-by gas 1 is treated in the closed circuit, so that environmental consequences by the release of the blow-by gas to the atmosphere are extremely petty.

Thus, according to the above embodiment, while the engine 3 remains cold, the passage of the three-way valve 13 can be temporarily switched for release of the blow-by gas 1 to the atmosphere, whereby production and accumulation of dew condensation water in the system while the engine 3 remains cold can be prevented beforehand, so that facilitated mixing of dew condensation water with the oil 8 due to vibration into a highly viscous emulsion can be prevented. As a result, fear of malfunction of the non-return valves and passage clogging in the ventilator and in the oil recovery tube due to this kind of emulsion can be resolved.

Production of the dew condensation water itself in the system while the engine 3 remains cold can be prevented, which can make it unnecessary to incorporate in the oil recovery tube 9 a catch tank 12 (see FIG. 1) for separation of dew condensation water, and thus bring about substantial reduction in cost and can make it unnecessary to conduct troublesome and periodical removal of the dew condensation water and the oil 8 from the catch tank 12 (see FIG. 1) and cleaning of the interior of the tank.

It is to be understood that a closed breather system according to the invention is not limited to the above embodiment and that various changes and modifications may be made without departing from the scope of the invention. For example, the cold-condition determining means is not restricted to the water temperature sensor for temperature detection of cooling water in an engine, and may be of different type adapted to determine the engine to be in cold condition.

### REFERENCE SIGNS LIST

1 blow-by gas
2 ventilator
3 engine
5 gas extraction tube
7 intake tube
13 three-way valve
14 controller
15 water temperature sensor (cold-condition determining means)
15a detection signal

1. A closed breather system for returning blow-by gas extracted from an engine through a gas extraction tube to an intake tube, oil mist being separated and recovered from the blow-by gas through a ventilator, wherein a three-way valve is incorporated in said gas extraction tube such that a passage of said three-way valve is temporarily switched only while the engine remains cold so as to release the blow-by gas to atmosphere.

2. The closed breather system as claimed in claim 1 further comprising cold-condition determining means for determining the engine to be in cold condition and a controller for switching a passage of the three-way valve on the basis of a detection signal from said cold-condition determining means to release the blow-by gas to the atmosphere.

3. The closed breather system as claimed in claim 2 wherein the cold-condition determining means is a water temperature sensor for detecting temperature of cooling water in the engine.
